(19) United States
(12) Patent Application Publication
(10) Pub. No.: US 2024/0229937 A9
(43) Pub. Date: Jul. 11, 2024

(54) SAFETY VALVES, VEHICLES AND FUELING STATIONS INCLUDING THE SAME, AND RELATED METHODS

(71) Applicant: NATURAL GAS FUEL SYSTEMS, LLC, ROANOKE, TX (US)

(72) Inventors: Michael Zimmerman, Trophy Club, TX (US); Chris Culberson, Denton, TX (US); Adam Strouhal, Grapevine, TX (US)

(73) Assignee: NATURAL GAS FUEL SYSTEMS, LLC, ROANOKE, TX (US)

(21) Appl. No.: 18/358,554

(22) Filed: Jul. 25, 2023

Related U.S. Application Data
(60) Provisional application No. 63/392,053, filed on Jul. 25, 2022.

(51) Int. Cl. F16K 1/12; F16K 15/06

(52) U.S. Cl. CPC F16K 1/126; F16K 15/063

(57) ABSTRACT

This disclosure includes safety valves, vehicles and fueling stations having the same, and related methods. Some safety valves have a valve body defining a fluidic network including an inlet and an outlet, a piston disposed within and movable relative to the valve body between a first position in which the inlet is in fluid communication with the outlet and a second position in which fluid communication between the inlet and the outlet is prevented, and a heat-defeatable barrier that prevents movement of the piston to the second position. In some safety valves, the piston is biased toward the second position. In some safety valves, the piston includes a channel disposed between first and second ends of the piston, and when the piston is in the first position, the inlet is in fluid communication with the outlet via the channel.

### CROSS REFERENCE TO RELATED APPLICATION

The present application claims the benefit of priority to U.S. Provisional Patent Application Ser. No. 63/392,053, filed Jul. 25, 2022, the entire contents of which are hereby incorporated by reference in their entirety.

### FIELD OF INVENTION

The present invention relates generally to safety valves and, more specifically but without limitation, to safety valves for shutting off fuel flow to a vehicle's tanks in response to heat caused by, for example, a fire.

### BACKGROUND

Some vehicles, such as compressed natural gas (CNG) vehicles, include a fuel system having a pressure-relief device (PRD) that vents fuel from the vehicle's tanks if the pressure within and/or temperature of the fuel system becomes too high, which might otherwise cause a fuel-system explosion. The PRD is thus an important safety item.

Problems can arise, however, if the vehicle is being fueled. In that circumstance, the PRD may operate to vent a continuous supply of fuel from the fueling station—not just that in the vehicle's tanks. This problem can be compounded because, in some instances, a fueling station fuels vehicles while they are unattended, for example, overnight. Further, PRDs are designed to vent fuel from a vehicle's fuel system in order to prevent rupture of the fuel system's components. But if the fuel system is continuing to receive fuel from the fueling station, the PRD may be incapable of venting sufficient fuel to achieve that objective.

### SUMMARY

Some of the present safety valves can address these issues (and others) by having a valve body defining an interconnected fluidic network that includes an inlet, an outlet, and a flow path between the inlet and the outlet, a piston disposed within and movable relative to the valve body between a first position in which the inlet is in fluid communication with the outlet via the flow path and a second position in which fluid communication between the inlet and the outlet via the flow path is prevented, and a heat-defeatable barrier that prevents movement of the piston to the second position. To illustrate, such a safety valve can be placed in fluid communication between a fueling station's tanks and a vehicle's tanks and shut off fuel flow between the same once the heat-defeatable barrier fails and allows the piston to move to the second position.

To encourage movement of the piston to the second position upon failure of the heat-defeatable barrier, the piston in some safety valves can be biased toward the second position via, for example, pressure internal and/or external to the fluidic network and/or a spring. In some safety valves, this biasing can be accomplished by pressure acting on the piston that is internal to the fluidic network but outside of the flow path, which can provide the benefits of piston-biasing without, for example, requiring additional components and/or unduly restricting flow along the flow path (when the piston is in the first position).

In some safety valves, the piston includes a first end, a second end, and a channel disposed between the first and second ends, and when the piston is in the first position, the inlet is in fluid communication with the outlet via the flow path and the channel. Such a configuration can, for example, facilitate placement of the heat-defeatable barrier in a location exposed to an environment around the safety valve (e.g., as shown in FIGS. 1A-2) or close to the exterior of the safety valve, thereby aiding in the heat-defeatable barrier's operation and inspection.

Some of the present safety valves comprise a valve body defining an interconnected fluidic network including an inlet, an outlet, and a flow path between the inlet and the outlet, a piston disposed within and movable relative to the valve body between a first position in which the inlet is in fluid communication with the outlet via the flow path and a second position in which fluid communication between the inlet and the outlet via the flow path is prevented, wherein the safety valve is configured such that pressure within the fluidic network outside of the flow path biases the piston toward the second position, and a heat-defeatable barrier that prevents movement of the piston to the second position.

In some safety valves, the piston includes a first end that is exposed to pressure within the fluidic network and a second end that is isolated from pressure within the fluidic network. In some safety valves, the piston includes a channel, when the piston is in the first position, the flow path passes through the channel, and when the piston is in the second position, the piston prevents fluid communication between the inlet and the outlet via the flow path by obstructing the flow path. In some safety valves, as the piston moves from the first position to the second position, the piston moves transversely relative to a portion of the flow path to obstruct and thereby prevent fluid communication through the portion of the flow path. In some safety valves, when the piston is in the first position, the piston abuts the heat-defeatable barrier.

Some of the present safety valves comprise a valve body defining an interconnected fluidic network including an inlet, an outlet, and a flow path between the inlet and the outlet, a piston disposed within the valve body, the piston including a first end, a second end, and a channel disposed between the first and second ends, wherein the piston is movable relative to the valve body transversely to the channel between a first position in which the inlet is in fluid communication with the outlet via the flow path and the channel and a second position in which the piston prevents fluid communication between the inlet and the outlet via the flow path by obstructing the flow path, and a heat-defeatable barrier that prevents movement of the piston to the second position. In some safety valves, the piston is not biased toward the second position via a spring.

In some safety valves, the heat-defeatable barrier is configured to fail upon reaching a temperature of from approximately 100° C. to approximately 120° C. In some safety valves, the heat-defeatable barrier is configured to fail by melting. In some safety valves, the heat-defeatable barrier comprises a frangible reservoir containing a fluid configured to expand and rupture the reservoir in response to heat.

Some of the present vehicles comprise a tank configured to store pressurized fuel, a fill port configured to receive pressurized fuel for storage in the tank, and at least one of the present safety valves disposed in fluid communication between the fill port and the tank such that, to flow from the fill port to the tank, pressurized fuel flows from the inlet and through the outlet.

Some of the present vehicles comprise a tank configured to store pressurized fuel, a fill port configured to receive pressurized fuel for storage in the tank, and a safety valve disposed in fluid communication between the fill port and the tank, the safety valve having a piston that is movable between a first position in which the safety valve permits fluid communication between the fill port and the tank and a second position in which the safety valve blocks fluid communication between the fill port and the tank, and a heat-defeatable barrier that prevents movement of the piston to the second position. Some vehicles comprise a pressure-relief device configured to vent pressurized fuel from the tank. In some vehicles, the piston is biased toward the second position.

In some vehicles, the heat-defeatable barrier is configured to fail upon reaching a temperature of from approximately 100° C. to approximately 120° C. In some vehicles, the heat-defeatable barrier is configured to fail by melting. In some vehicles, the heat-defeatable barrier comprises a frangible reservoir containing a fluid configured to expand and rupture the reservoir in response to heat.

Some of the present methods comprise fueling a first one of the present vehicles at least by directing pressurized fuel through the fill port, through the safety valve, and into the tank. Some methods comprise fueling a second one of the present vehicles at least by directing pressurized fuel through the fill port, through the safety valve, and into the tank, wherein the first vehicle and the second vehicle are parked adjacent to one another. In some methods, the pressurized fuel is compressed natural gas (CNG) or hydrogen.

Some of the present fueling stations comprise a tank configured to store fuel, a nozzle configured to receive fuel from the tank and provide the received fuel to a vehicle, and at least one of the present safety valves disposed in fluid communication between the tank and the nozzle such that, to flow from the tank to the nozzle, fuel flows from the inlet and through the outlet. Some fueling stations comprise a compressor that is disposed upstream of the nozzle and configured to pressurize fuel that is subsequently received by the nozzle.

Some of the present methods comprise fueling a vehicle with one of the present fueling stations at least by connecting the nozzle to a fill port of the vehicle and directing fuel from the tank, through the safety valve, and into the fill port. In some methods, the fuel is CNG or hydrogen.

The term “coupled” is defined as connected, although not necessarily directly, and not necessarily mechanically; two items that are “coupled” may be unitary with each other. The terms “a” and “an” are defined as one or more unless this disclosure explicitly requires otherwise. In any disclosed embodiment, the term “approximately” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” “include” and any form thereof such as “includes” and “including,” and “contain” and any form thereof such as “contains” and “containing,” are open-ended linking verbs. As a result, an apparatus that “comprises,” “has,” “includes,” or “contains” one or more elements possesses those one or more elements but is not limited to possessing only those one or more elements. Likewise, a method that “comprises,” “has,” “includes,” or “contains” one or more steps possesses those one or more steps but is not limited to possessing only those one or more steps.

Any embodiment of any of the apparatuses, systems, and methods can consist of or consist essentially of—rather than comprise/have/include/contain—any of the described steps, elements, and/or features. Thus, in any of the claims, the term “consisting of” or “consisting essentially of” can be substituted for any of the open-ended linking verbs recited above in order to change the scope of the claim from what it would otherwise be using the open-ended linking verb.

Further, a device or system that is configured in a certain way is configured in at least that way, but it can also be configured in ways other than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1A is a cross-sectional, schematic view of a first embodiment of the present safety valves having a piston that is movable between a first position—the position shown—in which fluid communication between an inlet of the safety valve and an outlet of the safety valve is permitted and a second position in which fluid communication between the inlet and the outlet is prevented, and a meltable, heat-defeatable barrier that prevents movement of the piston to the second position.

FIG. 1B is a cross-sectional, schematic view of the safety valve of FIG. 1A, showing the piston in the second position.

FIG. 2 is a cross-sectional, schematic view of a second embodiment of the present safety valves that is otherwise similar to FIG. 1A's safety valve but includes a heat-defeatable barrier having a frangible reservoir containing a fluid that expands and ruptures the reservoir in response to heat.

FIG. 3A is a perspective, schematic view of one of the present vehicles that includes one of the present safety valves disposed in fluid communication between a fill port of the vehicle and fuel tanks of the vehicle.

FIG. 3B is a perspective, schematic view of the safety valve, fill port, fuel tanks, and related components of the vehicle of FIG. 3A.

FIG. 4 is a perspective, schematic view of three of the present vehicles during fueling.

FIG. 5 is a schematic view of one of the present fueling stations that includes one of the present safety valves disposed in fluid communication between fuel tanks of the fueling station and nozzles of the fueling station.

### DETAILED DESCRIPTION

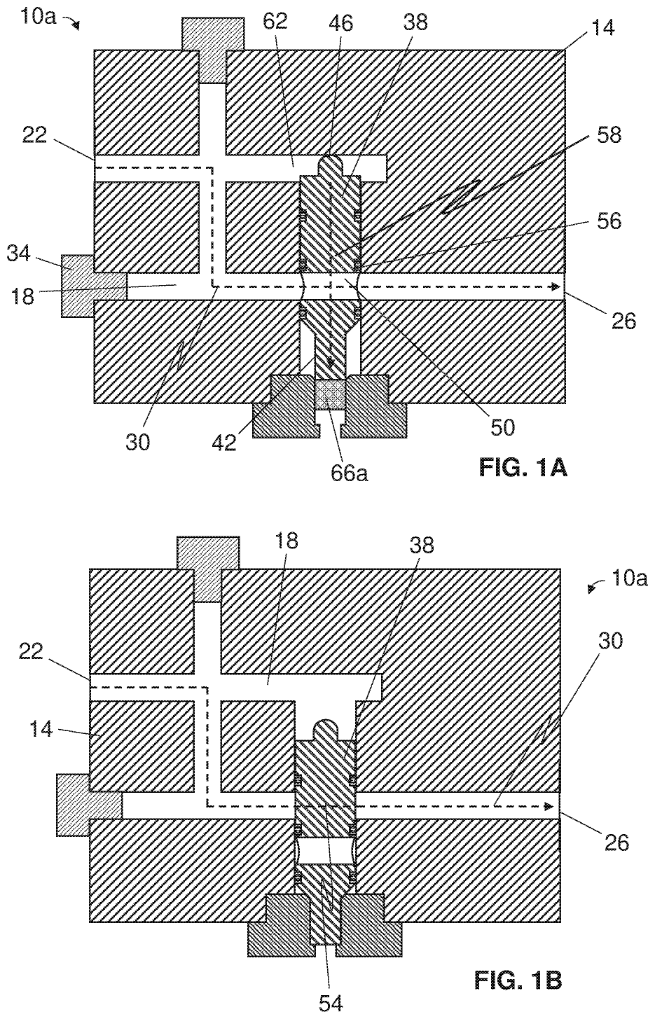

Referring now to the drawings, FIG. 1A depicts a first embodiment 10a of the present safety valves. Safety valve 10a includes a valve body 14 defining an interconnected fluidic network 18. Fluidic network 18 can be described as interconnected in that, for example, each portion of the network is in fluid communication with each other portion of the network via the network. As shown, fluidic network 18 has an inlet 22, an outlet 26, and a flow path 30 between the inlet and the outlet along which fluid can flow between the two. While shown blocked by plugs 34 in FIG. 1A, fluidic network 18 can have more than one inlet 22 (e.g., 2, 3, 4, 5, or more inlets). The fluidic network can also have more than one outlet 26 (e.g., 2, 3, 4, 5, or more outlets).

To control fluid flow through it, safety valve 10a includes a piston 38 that is disposed within and movable relative to valve body 14 between a first position (e.g., FIG. 1A) in which inlet 22 is in fluid communication with outlet 26, and a second position (e.g., FIG. 1B) in which fluid communication between the inlet and the outlet via flow path 30 is prevented. As used herein, “preventing” or “blocking” fluid communication is achieved even if such preventing or blocking is not complete. For example, when piston 38 is in the second position, fluid communication is “prevented” or “blocked” if a mass flow rate of fluid flow from inlet 22 to outlet 26 that is achievable is 10% or less (e.g., 5% or less, or 1% or less) of a mass flow rate of fluid flow from the inlet to the outlet that is achievable when the piston is in the first position, where those mass flow rates are measured for a same fuel and at a same inlet pressure that is suitable for fueling a vehicle with the fuel.

To illustrate, piston 38 can include a first end 42, a second end 46, and a channel 50 disposed between its first and second ends through which fluid can flow along flow path 30 when the piston is in the first position. By piston 38 including a channel 50, first end 42 of the piston can be disposed on an opposing side of flow path 30 from second end 46 of the piston, which can facilitate placement of heat-defeatable barrier 66a (described below) in a location exposed to an environment around safety valve 10a (e.g., as shown) or close to the exterior of the safety valve, thereby aiding in the heat-defeatable barrier's operation and inspection. And when piston 38 is in the second position, the piston can prevent fluid communication between inlet 22 and outlet 26 via flow path 30 by physically obstructing a portion 54 of the flow path. To prevent fluid from flowing around piston 38, whether it is in its first position or its second position, the piston can include seals 56.

Movement of piston 38 between the first and second positions can be effectuated by pressure within fluidic network 18. To illustrate, second end 46 of piston 38 can be exposed to pressure within the network, and first end 42 of the piston can be isolated from pressure within the network by, for example, one or more of seals 56. In this way, if pressure within fluidic network 18 acting on second end 46 is greater than pressure acting on first end 42 (e.g., ambient pressure)—and heat-defeatable barrier 66a has failed—piston 38 can be moved to the second position. In other embodiments, movement of a piston (e.g., 38) can be effectuated by a spring, an electrical, hydraulic, pneumatic, or the like actuator, pressure outside of a fluidic network (e.g., 18), and/or the like, alone or in addition to pressure within the fluidic network. As shown, such movement of piston 38 can be in a direction 58 that is transverse to portion 54 of flow path 30 that the piston obstructs when it is in the second position and—if present—also transverse to channel 50.

In some safety valves, like 10a, piston 38 is biased toward the second position, which can encourage movement of the piston to the second position upon failure of heat-defeatable barrier 66a. In safety valve 10a, such biasing is accomplished by the same pressures that act to move piston 38 from the first position to the second position (described above), which achieves the benefits of piston-biasing without, for example, requiring additional components such as a spring. Further advantageously in safety valve 10a, pressure acting on piston 38's second end 46 is in a portion 62 of fluidic network 18 that is outside of flow path 30. Such can allow for pressure in fluidic network 18 to bias piston 38 toward the second position while not unduly restricting flow along flow path 30. Nevertheless, in other embodiments including such piston-biasing, it can be accomplished by, for example, pressure external to a fluidic network (e.g., 18), a spring, and/or the like, with or without pressure internal to the fluidic network.

To maintain piston 38 in the first position, safety valve 10a includes a heat-defeatable barrier 66a. To illustrate, when piston 38 is in the first position, heat-defeatable barrier 66a can physically prevent movement of the piston to the second position by, for example, abutting first end 42 of the piston. Heat-defeatable barrier 66a can be configured to fail upon reaching a threshold temperature that is greater than or approximately equal to any one of, or between any two of: 80, 90, 100, 110, 120, 130, and 140° C., such as a temperature of from approximately 100° C. to approximately 120° C. In safety valve 10a, such failure can be via heat-defeatable barrier 66a melting. For example, heat-defeatable barrier 66a can comprise a material having a melting point of the threshold temperature, including a eutectic material.

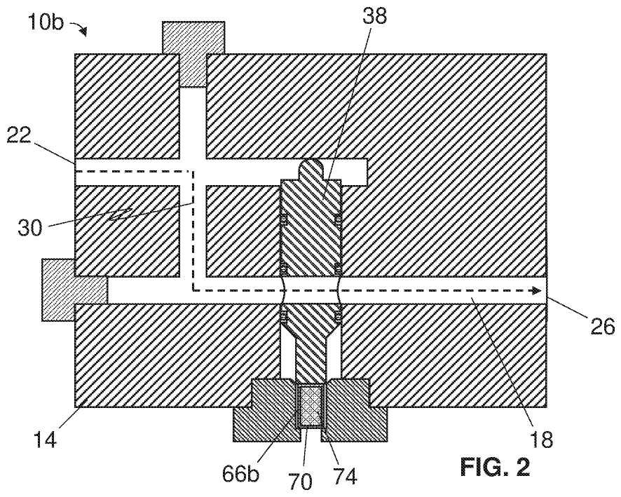

Nevertheless, any suitable heat-defeatable barrier can be used. For example, and referring to FIG. 2, shown is a second embodiment 10b of the present safety valves that is otherwise similar to safety valve 10a except that it includes a different heat-defeatable barrier 66b. In particular, heat-defeatable barrier 66b includes a frangible reservoir 70 containing a fluid 74 that expands in response to heat such that, at the threshold temperature, the fluid ruptures the reservoir. To illustrate, heat-defeatable barrier 66b can be similar to the bulbs used in fire sprinklers. And to further illustrate, reservoir 70 can comprise, for example, glass, and fluid 74 can comprise, for example, a glycerin-based fluid.

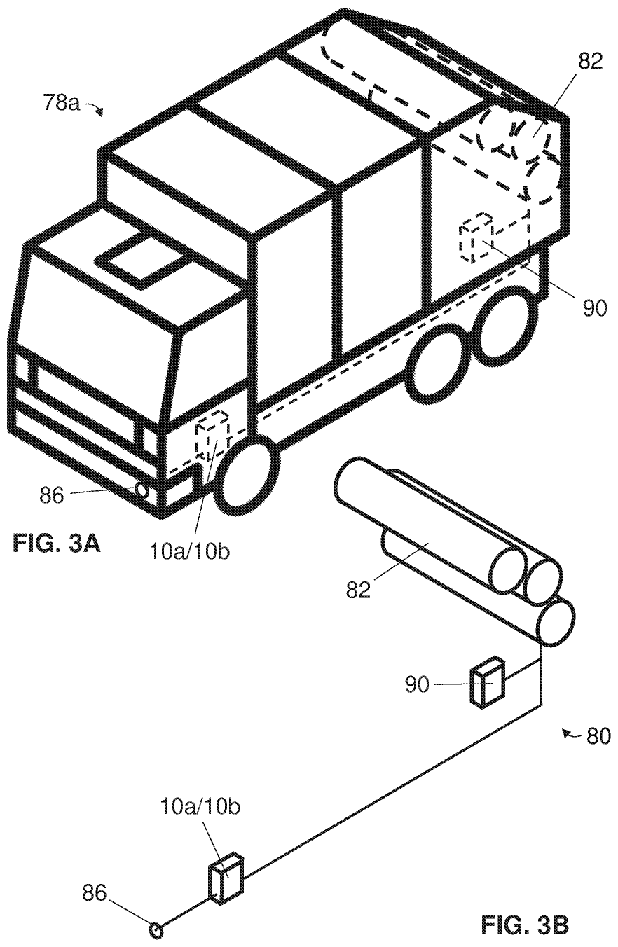

Turning now to FIGS. 3A and 3B, an illustrative use of the present safety valves is in a vehicle, such as vehicle 78a. Vehicle 78a can include a fuel system 80 having tanks 82 for storing pressurized fuel, such as, for example, CNG, hydrogen, or the like. Vehicle 78a can also include a fill port 86 for receiving pressurized fuel for storage in tanks 82. And as with many like vehicles, vehicle 78a can include a PRD 90 for venting pressurized fuel from tanks 82 in the event of excessive pressure and/or temperature in fuel system 80.

As shown, vehicle 78a further includes at least one of the present safety valves (e.g., 10a and/or 10b) disposed in fluid communication between fill port 86 and tanks 82 such that, to flow from the fill port to the tanks, pressurized fuel must flow from inlet 22 and through outlet 26. In this way, for example, should PRD 90 operate to vent fuel from tanks 82, the safety valve can operate to move its piston (e.g., 38) from the first position to the second position and thereby prevent the PRD from releasing pressurized fuel received from fill port 86 that it otherwise would have.

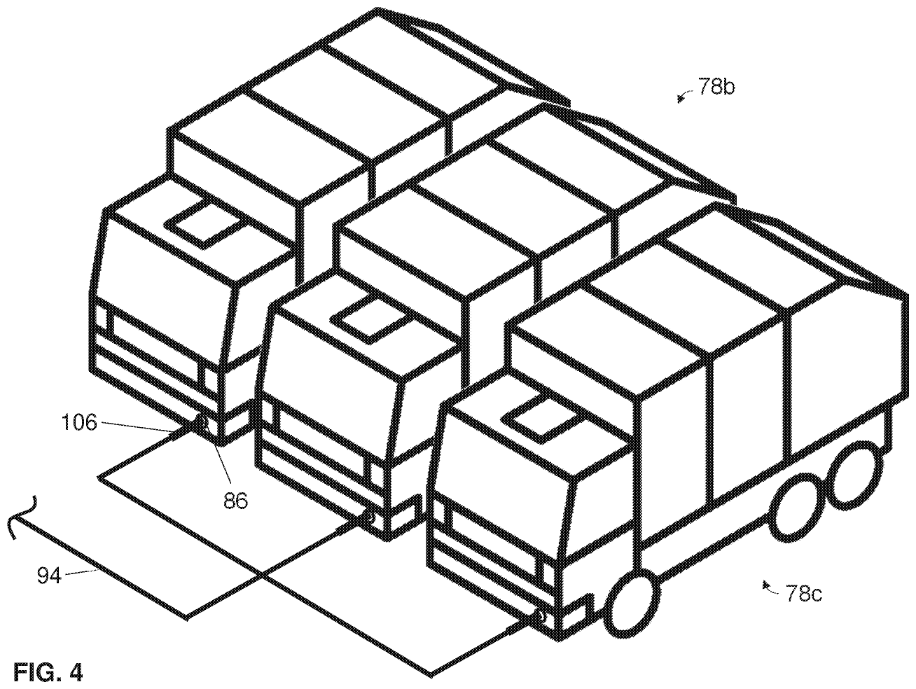

Referring now to FIG. 4, some of the present methods comprise fueling a first one of the present vehicles (e.g., 78a) at least by directing pressurized fuel (e.g., from a fueling line 94) through a fill port (e.g., 86) of the vehicle, through a safety valve (e.g., 10a and/or 10b) of the vehicle, and into tanks (e.g., 82) of the vehicle. Some methods further comprise fueling a second one of the present vehicles (e.g., 78b and/or 78c) at least by directing pressurized fuel (e.g., from the fueling line) through a fill port (e.g., 86) of the vehicle, through a safety valve (e.g., 10a and/or 10b) of the vehicle, and into tanks (e.g., 82) of the vehicle. In some methods, the first vehicle and the second vehicle are parked adjacent to one another. In some methods, the pressurized fuel is CNG. In some methods, the pressurized fuel is hydrogen.

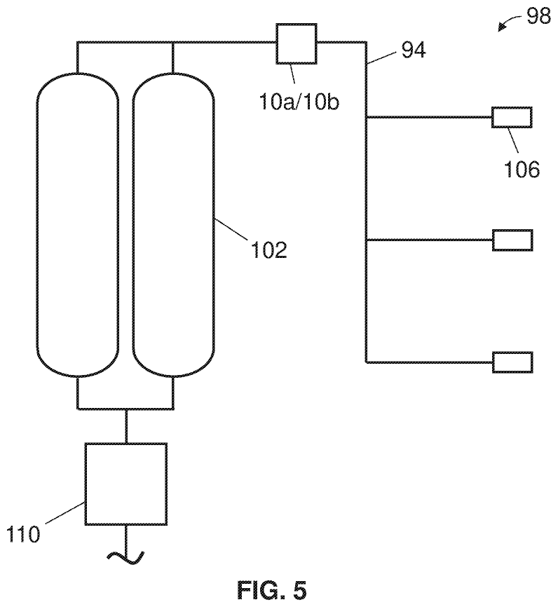

Turning now to FIG. 5, another illustrative use of the present safety valves is in a fueling station, such as fueling station 98. Fueling station 98 can include one or more tanks 102 configured to store fuel, one or more nozzles 106 configured to receive fuel from the tank(s) to provide that fuel to one or more vehicles, and one or more of the present safety valves (e.g., 10a and/or 10b), each disposed in fluid communication between at least one of the tank(s) and at least one of the nozzle(s) such that, to flow from the tank to the nozzle, fuel flows through an inlet (e.g., 22) of the safety valve and through an outlet (e.g., 26) of the safety valve. As shown, fueling station 98 can also include a compressor 110 disposed upstream of nozzle(s) 106, whether upstream (as shown) or downstream of tank(s) 102, that pressurizes fuel before its receipt by the nozzle(s).

The vehicle(s) can each be one of the present vehicles (e.g., 78a, 78b, or 78c) that includes at least one of the present safety valves, an otherwise similar vehicle that does not include one of the present safety valves, or another vehicle, provided it includes a fill port (e.g., 86) for interfacing with one of nozzle(s) 106. In this way, for example, the benefits of the present safety valves can be obtained even when fueling a vehicle that does not include at least one of them.

Some of the present methods comprise fueling a vehicle (e.g., 78a, 78b, or 78c) with one of the present fueling stations (e.g., 98) at least by connecting a nozzle (e.g., one of nozzle(s) 106) to a fill port (e.g., 86) of the vehicle and directing fuel from a tank (e.g., one of tank(s) 102), through at least one of the present safety valves (e.g., 10a and/or 10b), and into the fill port.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A safety valve comprising:
a valve body defining an interconnected fluidic network including:
an inlet;
an outlet; and
a flow path between the inlet and the outlet;
a piston disposed within and movable relative to the valve body between:
a first position in which the inlet is in fluid communication with the outlet via the flow path; and
a second position in which fluid communication between the inlet and the outlet via the flow path is prevented;
wherein the safety valve is configured such that pressure within the fluidic network outside of the flow path biases the piston toward the second position; and
a heat-defeatable barrier that prevents movement of the piston to the second position.

2. The safety valve of claim 1, wherein the piston includes:
a first end that is exposed to pressure within the fluidic network; and
a second end that is isolated from pressure within the fluidic network.

3. The safety valve of claim 1, wherein, when the piston is in the first position, the piston abuts the heat-defeatable barrier.

4. The safety valve of claim 1, wherein:
the piston includes a channel;
when the piston is in the first position, the flow path passes through the channel; and
when the piston is in the second position, the piston prevents fluid communication between the inlet and the outlet via the flow path by obstructing the flow path.

5. The safety valve of claim 1, wherein, as the piston moves from the first position to the second position, the piston moves transversely relative to a portion of the flow path to obstruct and thereby prevent fluid communication through the portion of the flow path.

6. A safety valve comprising:
a valve body defining an interconnected fluidic network including:
an inlet;
an outlet; and
a flow path between the inlet and the outlet;
a piston disposed within the valve body, the piston including:
a first end;
a second end; and
a channel disposed between the first and second ends;
wherein the piston is movable relative to the valve body transversely to the channel between:
a first position in which the inlet is in fluid communication with the outlet via the flow path and the channel; and
a second position in which the piston prevents fluid communication between the inlet and the outlet via the flow path by obstructing the flow path; and
a heat-defeatable barrier that prevents movement of the piston to the second position.

7. The safety valve of claim 6, wherein the piston is not biased toward the second position via a spring.

8. The safety valve of claim 6, wherein the heat-defeatable barrier is configured to fail upon reaching a temperature of from approximately 100° C. to approximately 120° C.

9. The safety valve of claim 6, wherein the heat-defeatable barrier is configured to fail by melting.

10. The safety valve of claim 6, wherein the heat-defeatable barrier comprises a frangible reservoir containing a fluid configured to expand and rupture the reservoir in response to heat.

11. A vehicle comprising:
a tank configured to store pressurized fuel;
a fill port configured to receive pressurized fuel for storage in the tank; and
a safety valve of claim 6 disposed in fluid communication between the fill port and the tank such that, to flow from the fill port to the tank, pressurized fuel flows from the inlet and through the outlet.

12. A vehicle comprising:
a tank configured to store pressurized fuel;
a fill port configured to receive pressurized fuel for storage in the tank; and
a safety valve disposed in fluid communication between the fill port and the tank, the safety valve having:
a piston that is movable between:
a first position in which the safety valve permits fluid communication between the fill port and the tank; and
a second position in which the safety valve blocks fluid communication between the fill port and the tank; and
a heat-defeatable barrier that prevents movement of the piston to the second position.

13. The vehicle of claim 12, wherein the piston is biased toward the second position.

14. The vehicle of claim 12, comprising a pressure-relief device configured to vent pressurized fuel from the tank.

15. The vehicle of claim 12, wherein the heat-defeatable barrier is configured to fail upon reaching a temperature of from approximately 100° C. to approximately 120° C.

16. The vehicle of claim 12, wherein the heat-defeatable barrier is configured to fail by melting.

17. The vehicle of claim 12, wherein the heat-defeatable barrier comprises a frangible reservoir containing a fluid configured to expand and rupture the reservoir in response to heat.

18-20. (canceled)

21. A fueling station comprising:
a tank configured to store fuel;
a nozzle configured to receive fuel from the tank and provide the received fuel to a vehicle; and
a safety valve of claim 6 disposed in fluid communication between the tank and the nozzle such that, to flow from the tank to the nozzle, fuel flows from the inlet and through the outlet.

22. The fueling station of claim 21, comprising a compressor that is disposed upstream of the nozzle and configured to pressurize fuel that is subsequently received by the nozzle.

23. (canceled)

24. (canceled)
